(19) United States
(12) Patent Application Publication
(10) Pub. No.: US 2006/0278820 A1
(43) Pub. Date: Dec. 14, 2006

(54) Semiconductor module

(75) Inventors: Takehiko Senba, Saitama (JP); Katsuhiro Sasaki, Miyagi (JP); Takeshi Misawa, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/450,271

(22) Filed: Jun. 12, 2006

(30) Foreign Application Priority Data
Jun. 10, 2005 (JP) 2005-171340

(51) Int. Cl. H01J 5/02

(52) U.S. Cl. 250/239

(57) ABSTRACT

An image sensor module is composed of a base, a CCD image sensor, a glass plate, and a gasket. The base has a chip chamber with an opening, in which the CCD image sensor is contained. The glass plate is bonded by an adhesive layer to a top surface of the base, and covers the opening. The gasket is held between the base and the glass plate. The gasket is disposed inside the adhesive layer and seals the chip chamber tightly, so that moisture in the surrounding air does not enter the chip chamber.

### BACKGROUND OF THE INVENTION

1. Field of the Invention

The present invention relates to a semiconductor module with a semiconductor chip contained in a package, and more particularly to a waterproof structure for the semiconductor module.

2. Description Related to the Prior Art

Digital cameras and Camera phones are provided with image sensor modules. The image sensor module has a package which contains an image sensor chip so as to protect a light receiving surface of the image sensor chip from dusts. Generally, the package is made of either plastic, metals, or ceramic, and the plastic is often used in these days because of ease of process and low cost.

The package has a package body and a cover. Formed in the package body is a chip chamber, in which the image sensor is contained. The transparent cover is placed on the package body and bonded thereto with an adhesive agent such as an epoxy resin. In this manner, the chip chamber is sealed for the protection from dusts.

Basically, the semiconductor chips such as the image sensors are weak to water, and unsuitable for a humid environment accordingly. The Japanese patent laid-open publication No. 08-078567 then discloses a semiconductor device which uses an adhesive resin consisting mainly of bisphenol S type epoxy to bond the cover to the package body, so that moisture (or water vapor) in the surrounding air does not enter the chip chamber.

However, with this structure, the moisture that is previously contained in the adhesive resin enters the chip chamber and, as a result, dew condensation occurs in the chip chamber. In this case, the dew drops sometimes fall on the semiconductor chip and cause a short circuit in the semiconductor chip. Furthermore, if the semiconductor chip is the image sensor, the light receiving surface of the image sensor may have the dew condensation. The amount of light received is therefore reduced, and high quality images are hardly obtained.

### SUMMARY OF THE INVENTION

In view of the foregoing, an object of the present invention is to provide a semiconductor module capable of preventing dew condensation in a chip chamber.

To achieve the above and other objects, the semiconductor module according to the present invention includes a waterproof member sandwiched between a package body and a cover for an airtight closure of the two, and an adhesive layer formed outside the waterproof member so as to bond the cover on the package body. The package body has the chip chamber for containing a semiconductor chip, and the chip chamber is covered by the cover. Preferably, the waterproof member is made of either rubber or resilient plastic, and formed into a frame shape. Instead, grease may be used as the waterproof member.

The semiconductor chip can be an image sensor chip which has a light receiving surface. In this case, the cover is made of a transparent material.

According to the semiconductor module of the present invention, the waterproof member protects the chip chamber from the entry of the moisture that is previously contained in the adhesive layer or that has passed through the adhesive layer. Therefore, dew condensation in the chip chamber is prevented. It is also possible, if the semiconductor chip is the image sensor chip, to prevent the dew condensation on the light receiving surface.

### BRIEF DESCRIPTION OF THE DRAWINGS

For more complete understanding of the present invention, and the advantage thereof, reference is now made to the following descriptions taken in conjunction with the accompanying drawings, in which:

FIG.1 is an exploded perspective view of an image sensor module according to the present invention; and

FIG.2 is a cross sectional view of the image sensor module.

### DESCRIPTION OF THE PREFFERED EMBODIMENTS

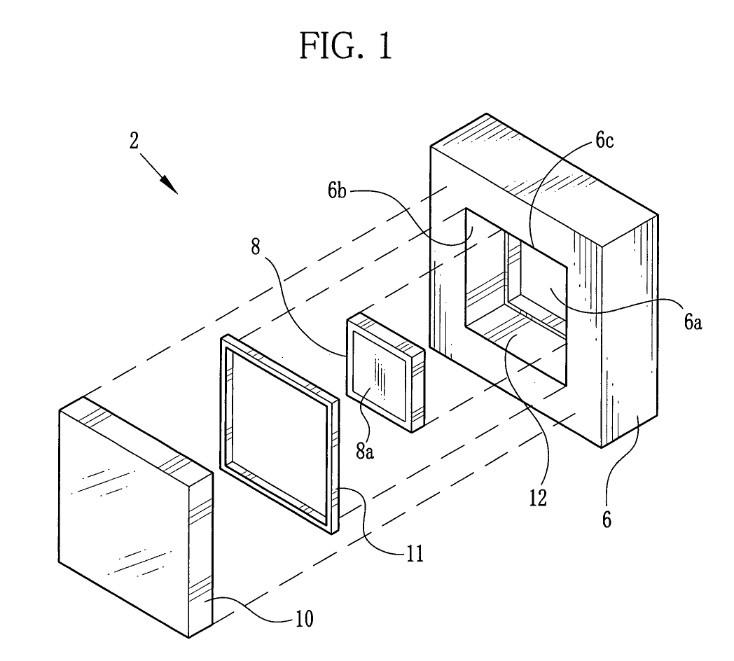

Referring to FIG.1, an image sensor module 2 includes a base 6 as a package body, a CCD image sensor 8 as a semiconductor chip, a glass plate 10 as a cover, and a gasket 11 that is a waterproof member. The base 6 has a chip chamber 12 defined by a mounting area 6a on which the CCD image sensor 8 is placed, a surrounding wall 6b that surrounds the mounting area 6a, and an opening 6c. The CCD image sensor 8 has a light receiving surface 8a, which faces the opening 6c when the CCD image sensor 8 is fixed to the mounting area 6a. The transparent glass plate 10 is attached to the base 6, and covers the opening 6c. The gasket 11 is formed into a frame shape whose inner periphery is almost the same size as the opening 6c. Accordingly, the chip chamber 12 is tightly sealed when the glass plate 10 is attached to the base 6. The base 6 is made of either an epoxy resin, a plastic resin such as a polyimide resin, or ceramic, and therefore able to dissipate heat of the CCD image sensor 8 effectively.

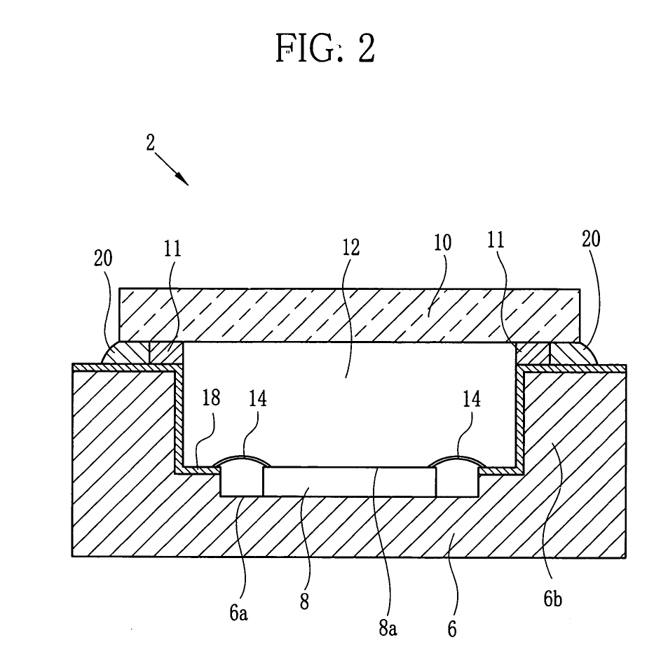

As shown in FIG.2, the glass plate 10 is attached to the top surface of the base 6 such that it faces the light receiving surface 8a of the CCD image sensor 8. Disposed around the light receiving surface 8a are plural electrodes (not shown), which transmit the electric signals generated by the CCD image sensor 8. The base 6 is provided with a wiring layer 18, whose one end is connected to the electrodes of the CCD image sensor 8 through bonding wires 14. The other end of the wiring layer 18 is exposed on the top surface of the base 6, and connected through a lead wire to a signal processing circuit that processes the output signals of the CCD image sensor 8.

Between the base 6 and the glass plate 10, the rubber made gasket 11 is inserted tightly. Formed outside the gasket 11 is an adhesive layer 20, which bonds the glass plate 10 to the base 6. Since the gasket 11 is disposed inside the adhesive layer 20, the moisture that is contained in the adhesive layer 20 or that passes through the adhesive layer 20 does not enter the chip chamber 12. Therefore, even when the ambient temperature goes much lower than the temperature inside the chip chamber 12, no dew condensation occurs in the chip chamber 12.

The operation of the present invention is now described. Firstly, the CCD image sensor 8 is placed in the chip chamber 12. Then, the electrodes of the CCD image sensor 8 are connected to the wiring layer 18 of the base 6 through the bonding wires 14, and the glass plate 10 is attached on the base 6. At this time, the frame-shaped rubber gasket 11 is inserted tightly between the base 6 and the glass plate 10. The adhesive layer 20 is then formed outside the gasket 11, and thereby the base 6 and the glass plate 10 are bonded together with the gasket 11 held in between. Being made of rubber, the gasket 11 protects the chip chamber 12 from the entry of moisture in the surrounding air. Accordingly, the dew condensation does not occur in the chip chamber 12.

Although the rubber made gasket 11 is used as the waterproof member in the above embodiment, the material of the gasket is not limited to this. For example, resilient plastic can be used for the gasket. Such plastic gasket will reduce the cost of the semiconductor module.

In the above embodiment, the semiconductor chip is the image sensor chip. However, the semiconductor chip is not limited to this, and may have transistors or thyristors formed therein.

Additionally, grease can be used as the waterproof member. In this case, the grease is molded to form a layer along the edge of the opening, and the adhesive layer is formed outside the grease layer so as to bond the glass plate to the base. The grease layer hardly flows because of its high viscosity, and in addition its oily nature prevents the entry of the moisture into the chip chamber.

For more effective prevention against the entry of the moisture into the chip chamber, the adhesive layer may be constitute of an adhesive agent with high sealing property. The high sealing adhesive agent may be, for example, polyurethane adhesive. This adhesive layer blocks passage of moisture, and provides more effective prevention against the entry of moisture into the chip chamber when combined with the waterproof member.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. A semiconductor module comprising:
a semiconductor chip;
a package body with a chip chamber in which said semiconductor chip is contained;
a cover attached on a top surface of said package body so as to cover said chip chamber;
a waterproof member sandwiched between said package body and said cover so as to provide an airtight closure of said package body and said cover; and
an adhesive layer disposed outside said waterproof member and bonding said package body and said cover together.

2. A semiconductor module as claimed in claim 1, wherein said waterproof member is formed into a frame shape.

3. A semiconductor module as claimed in claim 2, wherein said waterproof member is made of rubber or resilient plastic.

4. A semiconductor module as claimed in claim 1, wherein said waterproof member is grease.

5. A semiconductor module as claimed in claim 1, wherein said semiconductor chip is an image sensor chip having a light receiving surface and wherein said cover is made of a transparent material.
